(19) United States
(12) Patent Application Publication
(10) Pub. No.: US 2023/0305869 A1
(43) Pub. Date: Sep. 28, 2023

(54) DYNAMIC ALLOCATION OF HOST DEVICES IN BARE METAL DISTRIBUTED COMPUTING ENVIRONMENTS

(71) Applicant: Red Hat, Inc., Raleigh, NC (US)

(72) Inventors: Avishay Traeger, Modiin (IL); Moran Goldboim, Tal El (IL); Michael Filanov, Herzliya (IL); Michael Hrivnak, Raleigh, NC (US)

(21) Appl. No.: 17/703,038

(22) Filed: Mar. 24, 2022

(51) Int. Cl. G06F 9/455; G06F 9/50

(52) U.S. Cl. CPC G06F 9/45541; G06F 9/5044; G06F 2209/505

(57) ABSTRACT

Systems and methods for dynamically allocating host devices in distributed computing environments are provided. In one embodiment, a method is provided that includes receiving a request to execute multiple instances of a software application within a distributed computing environment. The distributed computing environment may be a bare metal computing environment in which application code is executed directly by computing hardware. At least one computing resource requirement, including at least one minimum resource requirement, may be identified and computing resource information may be received from a first plurality of host devices. Based on the computing resource information, a second plurality of host devices may be identified from among the first plurality of host devices that fulfill the minimum resource requirement. At least a subset of the second plurality of host devices may be assigned to a cluster used to execute the multiple instances of the software application.

### BACKGROUND

Multiple computing devices, or computing hosts, may be utilized to execute various software applications. For example, software applications may be executed by multiple computing devices within cloud computing environments and/or other types of distributed computing environments.

### SUMMARY

The present disclosure presents new and innovative systems and methods for dynamically allocating host devices in distributed computing environments. In one aspect, a method is provided that includes receiving a request to execute multiple instances of a software application within a distributed computing environment. The distributed computing environment may be a bare metal computing environment in which application code is executed directly by computing hardware. At least one computing resource requirement, including at least one minimum resource requirement, may be identified and computing resource information may be received from a first plurality of host devices. Based on the computing resource information, a second plurality of host devices may be identified from among the first plurality of host devices that fulfill the minimum resource requirement. At least a subset of the second plurality of host devices may be assigned to a cluster used to execute the multiple instances of the software application.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system according to an exemplary embodiment of the present disclosure.

FIG. 2 illustrates a host inventory according to an exemplary embodiment of the present disclosure.

FIG. 3 illustrates a request scenario according to an exemplary embodiment of the present disclosure.

FIG. 4 illustrates a method for selecting host devices according to an exemplary embodiment of the present disclosure.

FIG. 5 illustrates a method for selecting host devices according to an exemplary embodiment of the present disclosure.

FIG. 6 illustrates a system according to an exemplary embodiment of the present disclosure.

### DETAILED DESCRIPTION OF EXAMPLE EMBODIMENTS

Typically, distributed computing applications are executed within a cloud computing environment that utilizes one or more virtualization layers to execute the software applications using multiple computing devices. Such virtualization layers make it easier to provision the distributed applications amongst multiple computing devices within the cloud computing environment. However, the virtualization layer can often introduce various performance delays, for example, increasing startup time required for the distributed applications in reducing the overall computing resources available to execute distributed applications, as a certain proportion of the computing devices available must be used to establish and maintain the virtualization layer.

To address these concerns, bare metal provisioning may be used to assign distributed applications to particular host devices (e.g., particular pieces of hardware within a distributed computing environment). For example, assigning a software application to a particular host device with particular computing hardware may include installing an operating system and/or hypervisor directly onto the computing hardware in order to implement and execute the distributed application. In practice, applications may be assigned to multiple host devices and/or multiple pieces of computing hardware, depending on the operational requirements of the software application.

However, the initial assignment of which computing devices execute particular software application is significantly more important for bare metal assignments of computing devices than for assignments in virtual environments. In particular, virtualization may allow computing environments to adjust which computing devices execute a software application as the software application is in progress. However, because bare metal computing environments do not have a virtualization layer, such assignments may typically be more static and may be harder to change while execution of a software application is in process. Accordingly, it is significantly more essential to determine which computing devices should implement a particular software process at the outset to avoid wasting computing resources (e.g., by stopping and restarting software applications, waiting for communications with increased latency). Therefore, there exists a need to identify and assign bare metal computing hosts that comply with one or more user-specified requirements.

One solution to this problem is to utilize a tiered disclosure of host device information to select the host devices to be included within clusters that execute software applications. In particular, requests to execute a software application within a bare metal distributed computing environment may contain multiple types of requirements, including computing resource requirements for the individual host devices and/or cluster requirements that must be true amongst and between all host devices included within the cluster. To fulfill these requirements, a distributed computing environment (e.g., a clustering service executing within a bare metal distributed computing environment) may request computing resource information regarding the host devices and may identify which individual host devices comply with the computing resource requirements within the request. The distributed computing environment may then request additional, follow-up information from the qualified host devices, including location information (e.g., where the host devices are located) and/or network information (e.g., regarding network communication conditions between qualified host devices). Based on this received information, the distributed computing environment may select a combination of host devices that further comply with the cluster requirement. The selected host devices may then be assigned to implement a cluster within the distributed computing environment responsible for executing the software application.

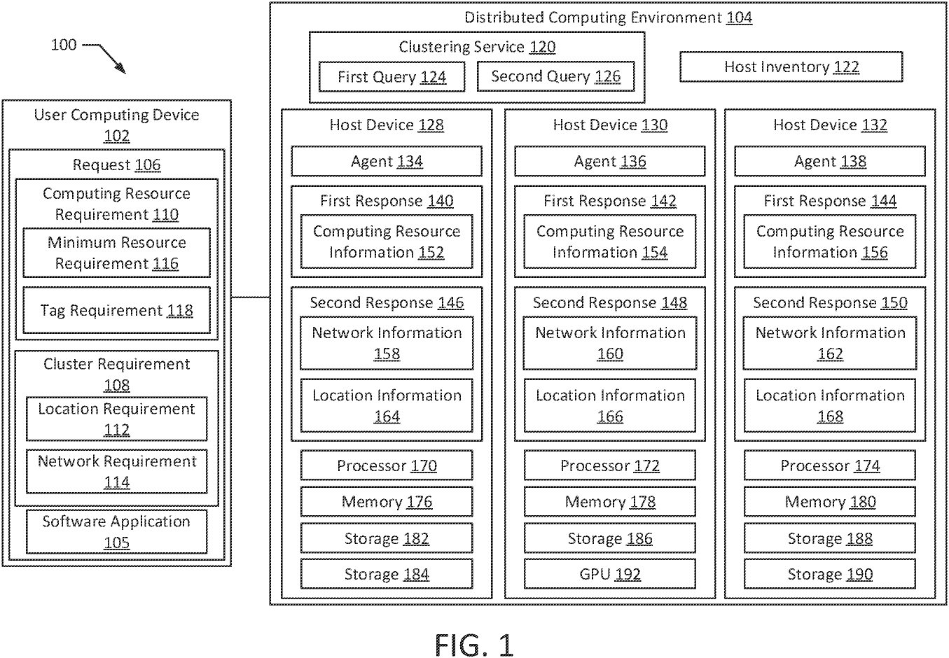

FIG. 1 illustrates a system 100 according to an exemplary embodiment of the present disclosure. The system 100 may be configured to select and assign host devices from a distributed computing environment to execute software applications. In particular, the host devices may be assigned according to one or more requirements received from a user and/or other software service.

In particular, the system 100 includes a user computing device 102 and a distributed computing environment 104. The user computing device 102 may be a computing device associated with a user (e.g., an individual user, such as a system administrator, a software service associated with a user executing on a computing device). For example, the user computing device 102 may include one or more of a server computing device (e.g., server grade computing hardware executing within a data center, distributed computing environment, or other server implementation), a personal computer, a laptop computer, a smart phone, a tablet computer, a wearable computing device, a smart speaker or other smart home device, a software service executing on a distributed computing environment (e.g., the distributed computing environment 104 and/or another distributed computing environment), and the like.

The distributed computing environment 104 may be configured to receive and execute software applications on behalf of users. In particular, the distributed computing environment 104 includes host devices 128, 130, 132. The distributed computing environment 104 may be configured to assign the host devices 128, 130, 132 to execute software or applications received from users. In particular, the host devices 128, 130, 132 include various configurations of computing hardware, including processors 170, 172, 174, memories 176, 178, 180, storage 182, 184, 186, 188, 190, and GPUs 192. As depicted, the host devices 128, 130, 132 may have hardware configurations that differ from one another. For example, the host devices 128, 132 include two storage devices 182, 184, 188, 190, while the host device 130 only has one storage device 186. Additionally, the host device 130 has a GPU 192, while the host devices 128, 132 do not. In practice, the distributed computing environment 104 may have many more than the three host device is depicted. In such instances, the host devices may have many different configurations of hardware and/or software compatibility, as discussed further below.

Based on these hardware differences and other operational conditions (e.g., failure zones, latency), the distributed computing environment 104 may be configured to select between individual host devices 128, 130, 132 to implement a received software application. In particular, the distributed computing environment 104 includes a clustering service 120 that may be configured to select multiple host devices from among the host devices 128, 130, 132 to implement a cluster that is assigned to execute received software applications. In particular, the distributed computing environment 104 may receive a request 106 from the user computing device 102. The request 106 may identify a software application 105 for implementation by the distributed computing environment 104. In certain implementations, the request 106 may include an identifier of the software application 105 that may be used to retrieve the software application 105 (e.g., from a database or other repository). The request 106 may further specify additional requirements necessary for the clusters formed to execute the software application 105. In particular, the request 106 may include a cluster requirement 108 and/or a computing resource requirement 110. The clustering service 120 may be configured to receive the requirements 108, 110 and to select host devices 128, 130, 132 for the cluster used to execute the software application 105 based on these requirements 108, 110. Notably, the contents of the request 106 may differ in various implementations. For example, certain implementations (and/or certain requests 106) may omit an identifier of the software application 105. For example, the user computing device 102 may initially provide the requirements 108, 110 and may subsequently provide the software application 105 (e.g., in a separate, later request).

The computing resource requirement 110 may specify one or more requirements for computing resources contained within host devices 128, 130, 132 assigned to execute the software application 105. For example, the computing resource requirement 110 may include a minimum resource requirement 116 that identifies one or more minimum computing resources (e.g., minimum number of CPU cores minimum RAM, minimum storage) necessary to implement the software application 105. Additionally or alternatively, the computing resource requirement 110 may include a tag requirement 118. Tag requirements 118 may identify one or more tags that need to be applied to host devices 128, 130, 132 included within the cluster. The tags may represent a collection or predefined requirements (e.g., computing resource conditions) that must be fulfilled for a tag to apply to a corresponding host device 128, 130, 132. For example, tags may be used as shorthand for certain types of computing resource requirements (e.g., high-storage or high-performance). In such instances, the tag requirement 118 may be used in lieu of a minimum resource requirement 116 to ensure that any assigned host devices 128, 130, 132 have sufficient computing resources. As another example, the software application 105 may require certain software libraries that have compatibility requirements (e.g., certain machine learning libraries that require compatible GPU’s). In such instances, the tag requirement 118 may be used to ensure that any assigned host devices are compatible with these software libraries (e.g., using an ML-capable tag).

The cluster requirement 108 may include one or more requirements that must be true amongst and between all host devices assigned to a cluster for the software application 105. For example, the cluster requirement 108 may include a location requirement 112 specifying specific and/or relative location conditions for the host devices 128, 130, 132. For example, the location requirement 112 may specify that all assigned host devices 128, 130, 132 be located within a particular geographical region (e.g., US Northeast). As another example, the location requirement 112 may specify that all selected host devices should be within the same geographic region and/or the same facility. As a still further example, the location requirement 112 may specify that host devices included within an assigned cluster be spread across the predetermined number (e.g., 2, 3, 5, 10) of failure zones. Failure zones may represent structurally distinct collections of computing hardware (e.g., host devices) within a distributed computing environment 104. For example, different failure zones may be located in different geographical regions, different facilities in a particular geographical region, different buildings within the same facility, different server deployments within the same building, different subnets, and/or different power circuits within the same building. In certain instances, the conditions necessary to qualify as different failure zones may be predefined (e.g., by the user, by an organization associated with the user, by an organization or administrator associated with the distributed computing environment 104). The network requirement 114 may specify one or more conditions that may be true about network communications between host devices assigned to a cluster for the software application 105. For example, the network requirement 114 may indicate that the assigned host devices should be located within the same subnet of a network within the distributed computing environment 104.

Upon receiving the request 106, the clustering service 120 may generate and transmit a first query 124 to the host devices 128, 130, 132. The first query 124 may request computing resource information from the host devices 128, 130, 132 within the distributed computing environment 104. In particular, the distributed computing environment 104 may transmit the first query 124 to a first plurality of host devices 128, 130, 132 within the distributed computing environment 104, and the first plurality of host devices 128, 130, 132 may, in turn, generate and transmit first responses 140, 142, 144 to the clustering service 120. The first responses 140, 142, 144 may contain computing resource information 152, 154, 156 for each of the host devices 128, 130, 132. In particular, as discussed further below, the computing resource information 152, 154, 156 may contain available capacities for one or more types of computing resources of the host devices 128, 130, 132 (e.g., number of available CPU cores, total memory capacity, storage capacity, GPU availability, and/or compatibility information for computing hardware). The clustering service 120 may receive the first responses 140, 142, 144 and may analyze the computing resource information 152, 154, 156 to determine whether any of the host devices 128, 130, 132 comply with the minimum resource requirement 116. For example, the minimum resource requirement 116 may indicate that a minimum of 64 CPU cores are required, and the computing resource information 154 may indicate that the host device 130 only has 32 available CPU cores. In such instances, the clustering service 120 may, based on this determination, remove the host device 130 from consideration for the cluster to implement the software application 105. In certain instances, the clustering service 120 may then select from among the host devices 128, 132 that comply with the minimum resource requirement 116 to form the cluster for the software application 105. Continuing the previous example, if the request 106 did not contain a cluster requirement 108 or a tag requirement 118, the clustering service 120 may select the host devices 128, 132 to form a cluster for the software application 105 based on their compliance with the minimum resource requirement 116.

In certain instances, however, the clustering service 120 may generate and transmit a second query 126 to a second plurality of host devices. For example, after identifying a second plurality of host devices that comply with the computing resource requirement 110, the clustering service 120 may generate and transmit a second query 126 requesting additional information (e.g., based on additional requirements, such as the cluster requirement 108 and/or one or more tag requirements 118). For example, the clustering service 120 may require additional information to determine whether one or more of the second plurality of host devices comply with the tag requirement 118 and/or the cluster requirement 108. In one particular example, the network requirement 114 may specify a maximum latency between host devices assigned to the cluster. Accordingly, the second query 126 may request that the host devices 128, 132 measure their latencies between other host devices from among the second plurality of host devices 128, 132. Similarly, if the cluster requirement 108 includes a location requirement 112, the second query 126 may cause the host devices 128, 130, 132 to determine and send location information 164, 166, 168 identifying, e.g., geographic regions, individual facilities and/or facility sectors in which the host devices 128, 130, 132 are located. In additional or alternative implementations, the location information 164, 166, 168 may instead be provided in the first responses 140, 142, 144. It should be appreciated that, in various implementations, the information requested by the first and second queries 124, 126 may differ. For example, in certain implementations, the first query may request location information and the first responses 140 may accordingly include the location information 164, 166.

In response to receiving the second query 126, the host devices 128, 130, 132 may determine and/or measure the requested information for inclusion within a second response 146, 148, 150 to the second query 126. For example, the host devices 128, 130, 132 may measure communication latencies between other host devices of the second plurality of host devices. Additionally or alternatively, the host devices 128, 130, 132 may determine location information (e.g., by querying an administrative process that maintains location information for each of the host devices, by retrieving previously-stored location information). The host devices 128, 130, 132 may then transmit the second responses 146, 148, 150 to the clustering service 120.

The clustering service 120 may then identify a third plurality of host devices 128, 130, 132 for inclusion within the cluster based on the first responses 140, 142, 144 and/or the second responses 146, 148, 150. For example, the clustering service 120 may determine, based on the network information 158, 160, 162, which of the host devices 128, 130, 132 comply with the network requirement 114 and may remove host devices that do not comply with the network requirement 114. For example, the network requirement 114 may specify a maximum latency between included host devices, the clustering service 120 may accordingly exclude combinations of host devices with communication latencies greater than the specified threshold. The clustering service 120 may similarly compare the location information 164, 166, 168 to the location requirement 112 and may select the included host devices such that the host devices as a whole comply with the location requirement 112 (e.g., are all located within the same geographical region, are spread across three or more failure zones, are not located within a specified country).

In certain instances, more host devices may comply with all of the requirements 108, 110 than are necessary to implement the cluster for the software application 105 (e.g., as identified by the request 106). In such instances, the clustering service 120 may select the included host devices based on one or more predetermined criteria. For example, the clustering service 120 may select the required number of host devices as the host devices that comply with all requirements 108, 110 and have the most available computing resources, the least available computing resources, the lowest aggregate communication latency, the highest average uptime, the lowest cost to a user, and the like.

The clustering service 120 may then assign the selected plurality of host devices 128, 130, 132 to a cluster within the bare metal distributed computing environment 104 that implements the software application 105. To do so, the clustering service 120 may update metadata corresponding to the host devices 128, 130, 132 to identify the newly-created cluster for the software application 105. Additionally or alternatively, the clustering service 120 may establish and/or reserve communication pathways between the host devices 128, 130, 132 for use in implementing the software application 105. In certain implementations, the distributed computing environment 104 may store and/or maintain a directory of software applications available via the distributed computing environment 104 and corresponding cluster identifiers and/or network endpoints. In such implementations, the clustering service 120 may update the directory to include an identifier of the software application 105 and the corresponding cluster created with the selected host devices. Once the cluster has been created and the host devices 128, 130, 132 have been assigned, requests for the software application 105 (e.g., API, HTTP, and/or other requests) may be received by the distributed computing environment 104, routed to the proper cluster, and processed and executed using the software application 105 executing on the bare metal of the host devices 128, 130, 132.

As discussed above, the clustering service 120 may request and receive information (e.g., computing resource information 152, 154, 156, network information 158, 160, 162, location information 164, 166, 168, and/or tag information) directly from host devices 128, 130, 132. In additional or alternative implementations, all or part of this information may instead be retrieved indirectly from a host inventory 122. The host inventory 122 may include a database of information received from host devices 128, 130, 132. For example, the clustering service 120 may regularly query host devices 128, 130, 132 (e.g., every hour, every day, when added to the distributed computing environment 104, when booted or rebooted) for computing resource information 152, 154, 156. This information, when received, may be added to the host inventory 122. In such instances, the first query may instead be transmitted to the host inventory 122, and the first responses may be received from the host inventory 122 (e.g., as a single response containing computing resource information for all host devices). Additionally or alternatively, the host devices 128, 130, 132 may retrieve the computing resource information 152, 154, 156 from the host inventory 122 for inclusion within the first responses 140, 142, 144. In additional or alternative implementations, upon receiving the computing resource information 152, 154, 156, the tag information, the network information 158, 160, 162, and/or the location information 164, 166, 168, the clustering service 120 and/or the distributed computing environment 104 may store this data within a host inventory 122. In certain instances, the clustering service 120 may only request information from the host devices 128, 130, 132 upon determining that the information within the host inventory 122 is stale (e.g., has not been updated for a predetermined period of time).

Any of the above-described techniques may be performed by a computing device using a processor and a memory. For example, the user computing device 102 and/or the distributed computing environment 104 may include a processor and a memory storing instructions which, when executed by the processor, cause the processor to perform one or more operational functions of the user computing device 102 and/or the distributed computing device. Furthermore, the clustering service 120 and/or the host inventory 122 may be implemented at least in part using a host device of the distributed computing environment 104. Additionally, the user computing device 102 and the distributed computing environment 104 may be configured to communicate using a network. For example, the user computing device 102 and the distributed computing environment 104 may communicate with the network using one or more wired network interfaces (e.g., Ethernet interfaces) and/or wireless network interfaces (e.g., Wi-Fi ®, Bluetooth ®, and/or cellular data interfaces). In certain instances, the network may be implemented as a local network (e.g., a local area network), a virtual private network, L1, and/or a global network (e.g., the Internet). Furthermore, the host devices 128, 130, 132 may also communicate with one another via one or more of the above-described networks and network interfaces. In certain instances, the network used for communication between host devices 128, 130, 132 may be separate from the network used for communication between the user computing device 102 and the distributed computing environment 104. For example, the distributed computing environment 104 and the user computing device 102 may communicate via a public network and the host devices 128, 130, 132 may communicate via a private network (e.g., an internal network for the distributed computing environment 104).

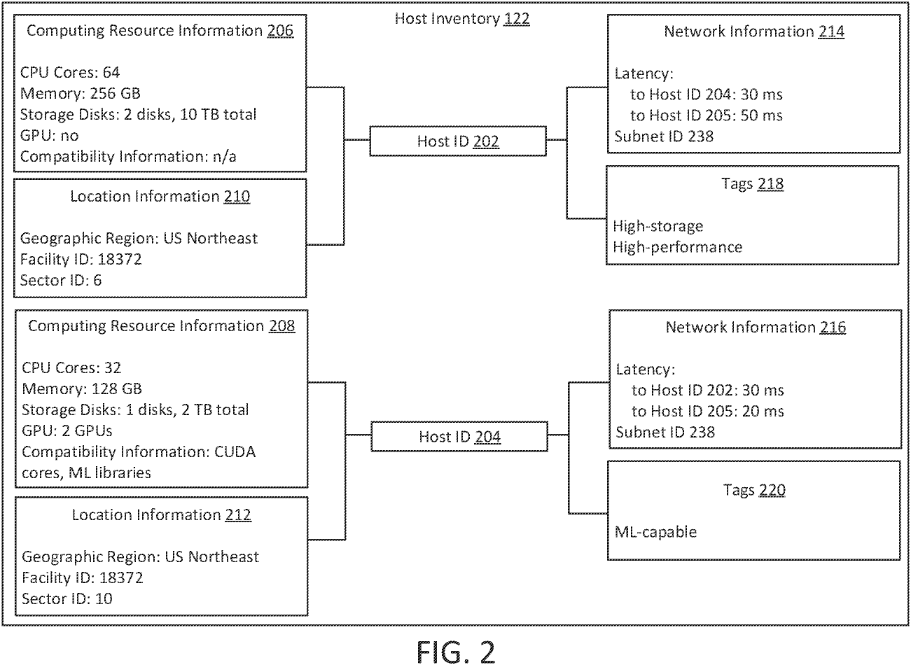

FIG. 2 illustrates a host inventory 122 according to an exemplary embodiment of the present disclosure. For example, the host inventory 122 may be an example implementation of the host inventory 122 within the distributed computing environment 104. The host inventory 122 may be updated by the clustering service 120 and/or the distributed computing environment 104, as explained above. The host inventory stores host IDs 202, 204, which may be associated with host devices of the distributed computing environment 104. For example, the host ID 202 may correspond to the host device 128, and the host ID 204 may be associated with the host device 130. The host IDs 202, 204 may be unique identifiers of the host devices 128, 130 (e.g., MAC addresses, device names, UUIDs). The host inventory 122 further stores computing resource information 206, 208, location information 210, 212, network information 214, 216, and tags 218, 220 in association with the host IDs 202, 204.

The computing resource information 206, 208 may be exemplary implementations of the computing resource information 152, 154. The computing resource information 206, 208 includes information on available resources for the associated host devices 128, 130. In particular, the computing resource information 206, 208 includes indications of the available CPU cores, memory capacity, storage disks, GPU availability, and/or compatibility information for the associated host devices 128, 130. In particular, the computing resource information 206 indicates that the host device 128 has 64 available CPU cores, 256 GB of available memory capacity to storage disks totaling 10 TB of data storage, no GPU, and no relevant compatibility information. The computing resource information 208 indicate that the host device 130 has 32 available CPU cores, 128 GB of available memory, one storage disk totaling 2 TB of data storage, 2 GPU’s, and is compatible with machine learning libraries and has CUDA cores (e.g., the GPUs 192 have CUDA cores capable of executing CUDA commands).

The location information 210, 212 may be exemplary implementations of the location information 164, 166. The location information 210, 212 may indicate one or more location measures for the associated host devices 128, 130. In particular, the location information 210, 212 includes indications of a geographic region, facility identifier, and sector identifier for the host devices 128, 130. In particular, the location information 210 indicates that the host device 128 is located in the US Northeast region, is located within a facility associated with the identifier 18372, and is located in sector 6 of that facility. The location information 212 indicates that the host device 130 is located within the US Northeast geographic region, is also located within the facility associated with the identifier 18372, but is located in sector 10 of that facility. Thus, the host devices 128, 130 located in the same facility, but are located within different sectors of that facility (e.g., within different buildings of the facility, within different server racks of the facility, within different network sectors for the facility).

The network information 214, 216 may be exemplary implementations of the network information 158, 160. The network information 214, 216 may include network performance measures for the associated host devices and/or may indicate all or part of a network structure containing the house devices 128, 130. For example, the network information 214, 216 includes latency measures between the host devices 128, 130 and other host devices, and a subnet identifier for the subnet (e.g., of a network within the distributed computing environment 104) for the host devices 128, 130. In particular, the network information 214 indicates that the host device 128 has a latency of 30 ms with the host device associated with host ID 204 (e.g., the host device 130), a latency of 50 ms with the host device associated with host ID 205, and a subnet ID of 238. The network information 216 indicates that the host device 130 has a latency of 30 ms with the host device associated with host ID 202 (e.g., host device 128), a latency of 20 ms with the host device associated with host ID 205, and is also on the subnet with ID 238.

The tags 218, 220 may represent tags associated with one or more host devices 128, 130, 132. In certain implementations, tags 218, 220 may be included within a first response 140, 142, 144 and/or a second response 146, 148, 150 for the host devices 128, 130, 132. As explained above, the tags may represent an indication that the associated host devices 128, 130, 132 meet one or more predefined requirements. For example, the tags may be defined by a user (e.g., associated with the user computing device 102), a network administrator (e.g., associated with the distributed computing environment 104), and/or other sources (e.g., industry standards for various types of computing applications). Exemplary tags 218 may include one or more of high-storage, high-performance, ML-capable, 3D-rendering-capable, high-efficiency, high-bandwidth, secure-hardware, and the like. The tags 218 indicate that the host device 128 has high storage and is high performance. The tags 220 indicates the host device 130 is machine learning capable. The tags may be determined by the clustering service 120, another service within the distributed computing environment, and/or the host devices 128, 130, 132 themselves. For example, high-storage tags may be applied to any host device after determining that the device has 8 TB of storage or more. Upon determining that the host device 128 has more than 8 TB of storage (e.g., based on the computing resource information 152, 206, the clustering service 120 may apply the high-storage tag to the host device 128 (e.g., by updating the host inventory 122). Similarly, the high-performance tag may be applied upon determining that the host device 128 has more than 48 available CPU cores and the ML-capable tag may be applied to the host device 130 after determining that its GPUs 192 have CUDA cores and are compatible with particular machine learning libraries (e.g., TensorFlow).

It should be understood that the data structures depicted and discussed herein are merely exemplary. In practice, one skilled in the art may recognize that various additional or alternative data structures may be used in connection with the described techniques. All such data structures are hereby considered within the scope of the present disclosure.

Additionally or alternatively, the information depicted within the host inventory 122 and discussed above in connection with the host inventory 122 may not be stored within the host inventory 122 in certain implementations. In such instances, the computing resource information 206, 208, the location information 210, 212, the network information 214, 216, and the tags 218, 220 may be exemplary representations of the computing resource information 152, 154, the network information 158, 160, the location information 164, 168, and tags associated with the host devices 128, 130.

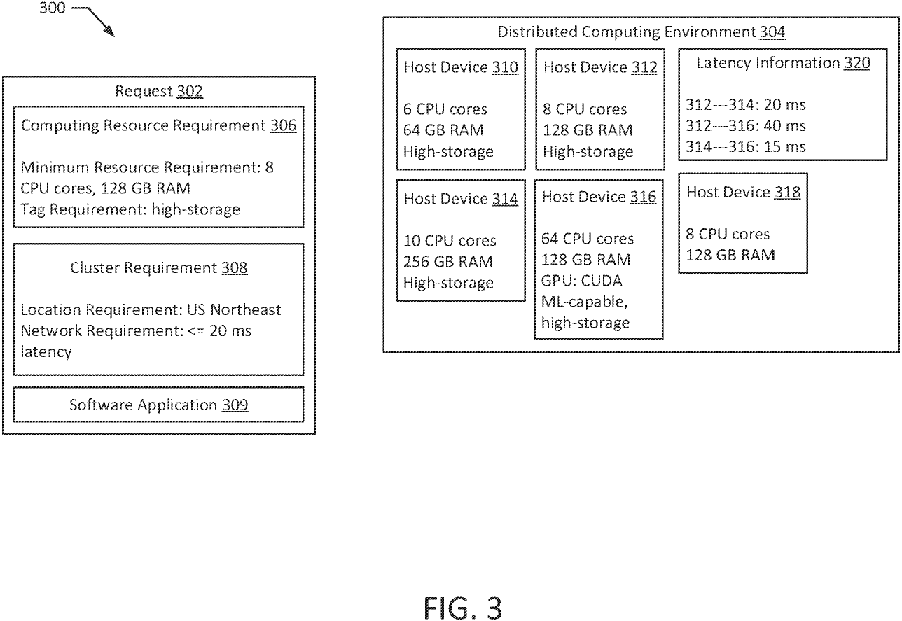

FIG. 3 illustrates a request scenario 300 according to an exemplary embodiment of the present disclosure. The scenario 300 may be performed to fulfill a request 302 to assign one or more host devices from a distributed computing environment 304 to a cluster implementing the software application 309. In particular, the scenario 300 represents an exemplary application of the system 100.

In the scenario 300, a request 302 is received that contains a computing resource requirement 306 and a cluster requirement 308 for a software application 309. The distributed computing environment 304 may receive the request 302 and may select between a plurality of host devices 310, 312, 314, 316, 318 to implement a cluster for the software application 309. In particular, the request 302 may specify that two host devices are needed for the cluster. It should be appreciated that the scenario 300 is simplified for clarity. In particular, clusters may typically need many more than two host devices (e.g., 5, 10, 50, 100, thousand, 10,000 host devices), and the distributed computing environment 304 may, in practice, have many more than five host devices (e.g., 100, 1000, 10,000, 100,000 host devices).

The computing resource requirement 306 indicates that a minimum of three CPU cores and 128 GB of RAM are needed, and that any included host device needs to include the high-storage tag (e.g., in lieu of specifying a particular, minimum amount of storage). The cluster requirement 308 indicates that the included host devices should be located in the US Northeast region, and that any included host devices need to have less than or equal to 20 ms of latency for communication between one another.

As depicted, the distributed computing environment 304 includes five host devices 310, 312, 314, 316, 318. All of the depicted host devices 310, 312, 314, 316, 318 may be located in the US Northeast region. For example, the distributed computing environment 304 may include additional host devices located in additional regions, which are not depicted in FIG. 3. The host device 310 has six available CPU cores 64 GB of RAM, and is associated with the high-storage tag. The host device 312 has eight available CPU cores, 128 GB of RAM, and is associated with the high-storage tag. The host device 314 has 10 CPU cores available, 256 GB of available RAM, and is associated with the high-storage tag. The host device 316 has 64 available CPU cores, 128 GB of available RAM, a CUDA capable GPU, and is associated with the ML-capable and high-storage tags. The host device 318 has eight available CPU cores and 128 GB of available RAM, and no associated tags.

In response to the request 302, the distributed computing environment 304 (e.g., a clustering service executing within the distributed computing environment 304) may request computing resource information and/or tag information for the host devices 310, 312, 314, 316, 318. The host devices 310, three 110, 314, 316, 318 may then respond by generating and transmitting the above-described resource information. Based on the received information, the distributed computing environment 304 may determine that the host devices 310, 318 do not comply with the computing resource requirement 306 and may accordingly be removed from consideration for the cluster implementing the software application 309. In particular, the host device 310 has fewer than eight available CPU cores and less than 128 GB of available RAM, and the host device 318 does not include the high-storage tag.

Additional information may be required to select between the remaining host devices 312, 314, 316. For example, the distributed computing environment 304 may need to ensure that selected host devices comply with the cluster requirement 308 (e.g., the network requirement for 20 ms or less of latency between selected host devices). To determine this, the distributed computing environment 304 may generate a second request for the host devices 312, 314, 316 requesting that the host devices 312, 314, 316 measured their latency between one another. The distributed computing environment 304 may then receive the results of these measurements, reflected in the latency information 320. In particular, the communication latency between host devices 312, 314 is 20 ms, the communication latency between host devices 312, 316 is 40 ms, and a communication latency between host devices 314, 316 is 15 ms.

Based on this information, the distributed computing environment 304 may determine that there are two viable pairs of host devices for use in the cluster implementing software application 309: host devices 312, 314 and host devices 314, 316. Notably, the combination of host devices 312, 316 is not viable, as communication latency between these host devices exceeds the network requirement. The distributed computing environment 304 may thus use either of the host device pairs to implement the requested cluster. In certain implementations, however, the distributed computing platform 304 may employ one or more strategies to select between the two viable options. As one example, the distributed computing environment 304 may select the host device combination with the lowest latency (e.g., host devices 314, 316). As another example, the distributed computing environment 304 may be configured to maintain the availability of specialized computing hardware, such as machine learning capable hardware and/or host devices with GPU. Because the software application 309 does not require a GPU (e.g., as indicated by the computing resource requirement 306), the distributed computing environment 304 may select a combination of host devices that minimizes the use of specialty hardware (e.g., host devices 312, 314). In the depicted example, the distributed computing environment 304 may thus assign the host devices 312, 314 to the cluster for the software application 309.

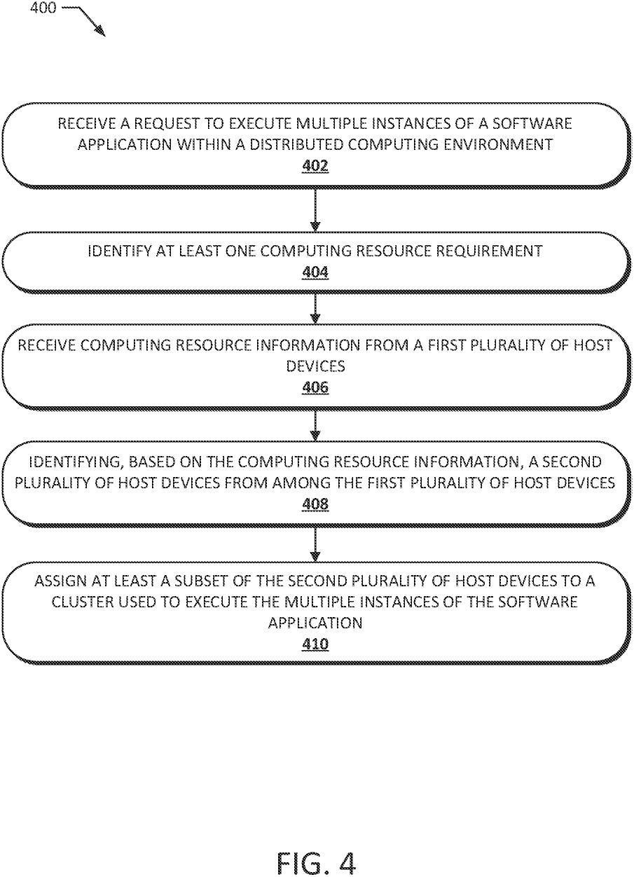

FIG. 4 illustrates a method 400 for selecting host devices according to an exemplary embodiment of the present disclosure. In particular, the method 400 may be performed to select between bare metal host devices in a distributed computing environment for use in a multi-device cluster implementing a requested software application. The method 400 may be implemented on a computer system, such as the system 100. For example, the method 400 may be implemented by the distributed computing environment 104, 304 and/or a clustering service 120. The method 400 may also be implemented by a set of instructions stored on a computer readable medium that, when executed by a processor, cause the computer system to perform the method 400. For example, all or part of the method 400 may be implemented by a processor and a memory within the distributed computing environment 104 (e.g., within a host device implementing the clustering service). Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

The method 400 may begin with receiving a request to execute multiple instances of a software application within a distributed computing environment (block 402). For example, the distributed computing environment 104, 304 may receive a request 106, 302 to execute multiple instances of a software application 105, 309 within the distributed computing environment 104, 304. As explained above, the distributed computing environment 104, 304 may be a bare metal computing environment in which application code for software applications 105, 309 is executed directly by computing hardware (e.g., without intervening virtualization layers). In particular, the distributed computing environment 104, 304 may receive the request 106, 302 to implement the software application 105, 309 using a cluster of multiple host devices 128, 130, 132, 310, 312, 314, 316, 318 within the distributed computing environment 104, 304. As explained above, the request 106, 302 may include one or more requirements, such as a computing resource requirement 110, 306 and/or a cluster requirement 108, 308.

At least one computing resource requirement may be identified (block 404). For example, the clustering service 120 may identify at least one computing resource requirement 110, 306 within the request 106, 302. As explained above, the computing resource requirement 110, 306 may specify at least one minimum resource requirement 116 and/or a tag requirement for one or more tags associated with host devices assigned to the cluster. As one specific example, the request 106, 302 may indicate that a minimum of 16 CPU cores, 256 GB of RAM, and a GPU with CUDA cores be included within each assigned host device. The request 106, 302 may further indicate that any assigned host devices must be compatible with machine learning libraries.

Computing resource information may be received from a first plurality of host devices (block 406). For example, the clustering service 120 may receive computing resource information 152, 154, 156, 206, 208 from a first plurality of host devices 128, 130, 132, 310, 312, 314, 316, 318 within the distributed computing environment 104, 304. As one particular example, the clustering service 120 may request computing resource information from all available host devices within the distributed computing environment 104, 304 that are available (e.g., that are not assigned to a cluster for another software application). To request the computing resource information 152, 144, 156, 206, 208, the clustering service 120 may transmit a first query 124 to the host devices 128, 130, 132, 310, 312, 314, 316, 318 and/or to a host inventory 122. In response, the host devices 128, 130, 132, 310, 312, 314, 316, 318 and/or the host inventory 122 may transmit the computing resource information 152, 154, 156, 158 to the clustering service 120. Continuing the previous example, the received computing resource information 152, 154, 156, 206, 208 may in number of CPU cores, total memory capacity, GPU information and/or one or more tags (e.g., ML compatibility tags).

A second plurality of host devices may be identified, based on the computing resource information, from among the first plurality of host devices (block 408). For example, the clustering service 120 may identify, based on the computing resource information 152, 154, 156, 206, 208, a second plurality of host devices 128, 130, 132, 312, 314, 316 from among the first plurality of host devices 128, 130, 132, 310, 312, 314, 316, 318 that fulfill the minimum resource requirement 116. Continuing the previous example the clustering service 120 may identify the second plurality of host devices as all host devices whose corresponding computer resource information indicates 16 or more available CPU cores 256 or more gigabytes of available RAM, a GPU with CUDA cores, and an ML-compatible tag. As another example, in the scenario 300, the distributed computing environment 304 may identify the second plurality of host devices as the host devices 312, 314, 316.

At least a subset of the second plurality of host devices may be assigned to a cluster used to execute the multiple instances of the software application (block 410). For example, the clustering service 120 may assign at least a subset of the second plurality of host devices 128, 130, 132, 312, 314, 316 to a bare metal computing cluster used to execute the multiple instances of the software application 105, 309. As explained above, assigning host devices 128, 130, 132, 312, 314, 316 to the cluster may include update on metadata associated with the host devices 128, 130, 132, 312, 314, 316 and/or establishing routing information for requests to the software application 105, 309 to include endpoints associated with at least one of the assigned host devices128, 130, 132, 312, 314, 316. Accordingly, requests received by the distributed cloud environment 104, 304 intended for the software application 105, 309 may be routed to at least one of the assigned host devices 128, 130, 132, 312, 314, 316 within the cluster, which will execute the software application 105, 309 based on the received request.

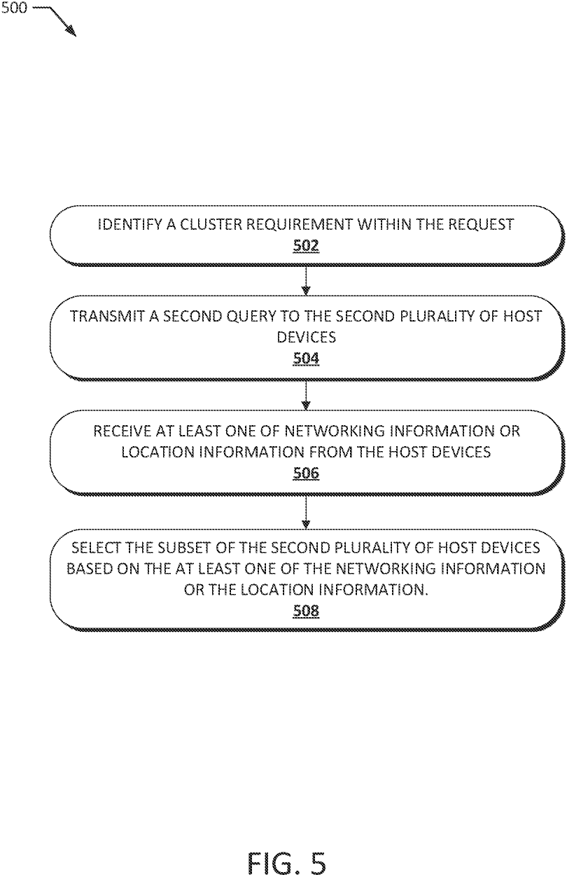

In certain instances (e.g., where the request 106, 302 specifies additional requirements), additional information may be required to further limit the second plurality of host devices to include host devices that comply with the additional requirement. For example, FIG. 5 illustrates a method 500 for selecting host devices based on additional requirements according to an exemplary embodiment of the present disclosure. The method 500 may be performed alongside of or as part of implementing the method 400. For example, the method 500 may be performed after block 408. The method 500 may be implemented on a computer system, such as the system 100. For example, the method 500 may be implemented by the distributed computing environment 104, 304 and/or a clustering service 120. The method 500 may also be implemented by a set of instructions stored on a computer readable medium that, when executed by a processor, cause the computer system to perform the method 500. For example, all or part of the method 500 may be implemented by a processor and a memory within the distributed computing environment 104 (e.g., within a host device implementing the clustering service). Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks described may be optional.

The method 500 may begin with identifying a cluster requirement within a request (block 502). For example, the clustering service 120 may identify a cluster requirement 108, 308 within the received request 106, 302 (e.g., received a block 402). As explained above, the cluster requirement 108, 308 may indicate one or more conditions that must be true between or amongst all host devices included within the cluster for the software application 105, 309. For example, the cluster 108, 308 may include one or more of a location requirement 112 and/or a network requirement 114. For example, the received request 106, 302 may indicate that host devices assigned to a cluster implementing the software application 105, 309 must be spread across at least two different geographic regions and at least three different failure zones with each geographic region.

The second query may be transmitted to the second plurality of host devices (block 504). For example, the clustering service 120 may transmit a second query 126 to a second plurality of host devices 128, 130, 312, 314, 316 (e.g., the second plurality of host devices identified at block 408). The second query 126 may request specific information (e.g., location information, network information) from the second plurality of host devices 128, 130, 132, 312, 314, 316 based on the contents of the identified cluster requirement 108, 308. Continuing the previous example, as the cluster requirement 108, 308 contained within the received request includes location requirements for both the geographic region and the failure zones for all assigned host devices, the second query 126 may request location information including a geographic region and failure zones (e.g., facility ID, sector ID) from the second plurality of host devices.

At least one of network information or location information may be received from the host devices (block 506). For example, the clustering service 120 may receive at least one of network information 158, 160, 162, 214, 216 and/or location information 164, 166, 168, 210, 212 from the second plurality of host devices 128, 130, 132, 312, 314, 316. In particular, the contents of the received information may differ depending on the contents of the second query 126. Continuing the previous example, the clustering service 120 may receive location information 164, 166, 168, 210, 212 from the second plurality of host devices 128, 130, 132 in response to the second query 126.

The subset of the second plurality of host devices may be selected based on at least one of the network information or the location information (block 508). For example, the clustering service 120 may select a subset of the second plurality of host devices 128, 130, 132, 312, 314, 316 based at least on the information received in response to the second query. Continuing the previous example, the clustering service 120 may select a subset of the second plurality of host devices such that the host devices are spread across at least two geographic regions and at least three failure zones (e.g., three different facility IDs, three different sector IDs). As explained above, in certain instances, there may be more than one eligible combination of host devices that comply with all of the requirements contained within the received request 106, 302. In such instances, the combination may be selected based on additional criteria (e.g., to minimize the amount of excess computing resources assigned to the cluster, to minimize the latency between assigned host devices, to avoid assigning host devices with specialized hardware when not necessary). The subset of the second plurality of host devices 128, 130, 132, 312, 314, 316 may then be assigned to implement the cluster for the requested software application 105, 309 (e.g., at block 410).

In this manner, the methods 400, 500 enable flexible allocation of host devices within a bare metal distributed computing environment. In particular, these techniques enable users to ensure that many types of requirements, including computing resource requirements and cluster-wide requirements are fulfilled for all host devices assigned to the cluster without having to manually select and assign the clusters. This system enables cloud-like flexibility for provisioning bare metal host devices while still preserving the performance benefits of executing applications within a bare metal computing environment as compared to a cloud or virtualized computing environment. Furthermore, the system may be readily extensible through the use of tags and tag requirements, as users in organizations are able to standardize various sets of host device requirements in tags that can be preassigned and/or dynamically assigned to host devices as needed. Furthermore, in the method 500, the ability to request additional follow-up information for necessary requirements (e.g., cluster requirements) enables the use of complex, interrelated requirements amongst the combinations of host devices (e.g., rather than individual requirements for individual host devices). Furthermore, as the follow-up information is requested only from the second plurality of host devices, unnecessary and wasteful communications are avoided (e.g., to host devices that do not comply with the individualized computing resource requirements).

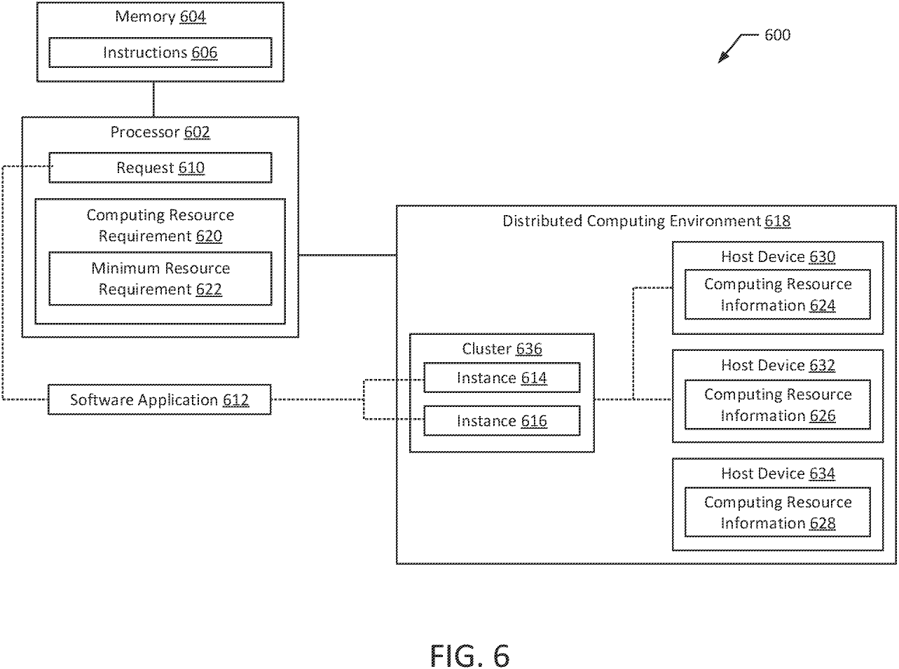

FIG. 6 illustrates a system 600 according to an exemplary embodiment of the present disclosure. The system 600 includes a processor 602 and a memory 604. The memory 604 stores instructions 606 which, when executed by the processor 602, cause the processor 602 to receive a request 610 to execute multiple instances 614, 616 of a software application 612 within a distributed computing environment 618. The distributed computing environment 618 may be a bare metal computing environment in which application code is executed directly by computing hardware. The instructions 606 may further cause the processor 602 to identify at least one computing resource requirement 620, including at least one minimum resource requirement 622 and receive computing resource information 624, 626, 628 from a first plurality of host devices 630, 632, 634. The instructions 606 may further cause the processor to identify, based on the computing resource information 624, 626, 628 a second plurality of host devices 630, 632 from among the first plurality of host devices 630, 632, 634 that fulfill the minimum resource requirement 622. At least a subset of the second plurality of host devices 630, 632 are assigned to a cluster 636 used to execute the multiple instances 614, 616 of the software application.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, GPUs or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving a request to execute multiple instances of a software application within a distributed computing environment, wherein the distributed computing environment is a bare metal computing environment in which application code is executed directly by computing hardware;
identifying at least one computing resource requirement, including at least one minimum resource requirement;
receiving computing resource information from a first plurality of host devices;
identifying, based on the computing resource information, a second plurality of host devices from among the first plurality of host devices that fulfill the minimum resource requirement; and
assigning at least a subset of the second plurality of host devices to a cluster used to execute the multiple instances of the software application.

2. The method of claim 1, wherein the at least one computing resource requirement further specifies a tag requirement.

3. The method of claim 2, wherein the method further comprises:
assigning tags to the first plurality host devices based on the computing resource information; and
identifying the second plurality of host devices as host devices that include one or more tags specified in the tag requirement.

4. The method of claim 2, wherein the tags are predefined according to at least one of predefined criteria and criteria specified in the request.

5. The method of claim 1, wherein identifying the second plurality of host devices further comprises:
identifying a cluster requirement within the request;
transmitting a second query to the second plurality of host devices;
receiving at least one of network information or location information from the host devices; and
selecting the subset of the second plurality of host devices based on the at least one of the network information or location information.

6. The method of claim 5, wherein the cluster requirement identifies a condition that must be fulfilled by the subset of the second plurality of host devices assigned to the cluster.

7. The method of claim 6, wherein the cluster requirement includes at least one of a location requirement and a network requirement.

8. The method of claim 1, further comprising identifying the first plurality of host devices as host devices that are available to execute software applications.

9. The method of claim 1, further comprising transmitting, to the first plurality of host devices within the distributed computing environment, a request for computing resource information.

10. The method of claim 1, wherein the request is received from a user computing device external to the distributed computing environment.

11. A system comprising:
a processor; and
a memory storing instructions which, when executed by the processor, cause the processor to:
receive a request to execute multiple instances of a software application within a distributed computing environment, wherein the distributed computing environment is a bare metal computing environment in which application code is executed directly by computing hardware;
identify at least one computing resource requirement, including at least one minimum resource requirement;
receive computing resource information from a first plurality of host devices;
identify, based on the computing resource information, a second plurality of host devices from among the first plurality of host devices that fulfill the minimum resource requirement; and
assign at least a subset of the second plurality of host devices to a cluster used to execute the multiple instances of the software application.

12. The system of claim 11, wherein the at least one computing resource requirement further specifies a tag requirement.

13. The system of claim 12, wherein the instructions further cause the processor to:
assign tags to the first plurality host devices based on the computing resource information; and
identify the second plurality of host devices as host devices that include one or more tags specified in the tag requirement.

14. The system of claim 12, wherein the tags are predefined according to at least one of predefined criteria and criteria specified in the request.

15. The system of claim 11, wherein the instructions further cause the processor, while identifying the second plurality of host devices, to:
identify a cluster requirement within the request;
transmit a second query to the second plurality of host devices;
receive at least one of network information or location information from the host devices; and
select the subset of the second plurality of host devices based on the at least one of the network information or location information.

16. The system of claim 15, wherein the cluster requirement identifies a condition that must be fulfilled by the subset of the second plurality of host devices assigned to the cluster.

17. The system of claim 16, wherein the cluster requirement includes at least one of a location requirement and a network requirement.

18. The system of claim 11, further comprising identifying the first plurality of host devices as host devices that are available to execute software applications.

19. The system of claim 11, wherein the request is received from a user computing device external to the distributed computing environment.

20. A non-transitory, computer-readable medium storing instructions which, when executed by a processor, cause the processor to:
receive a request to execute multiple instances of a software application within a distributed computing environment, wherein the distributed computing environment is a bare metal computing environment in which application code is executed directly by computing hardware;
identify at least one computing resource requirement, including at least one minimum resource requirement;
receive computing resource information from a first plurality of host devices;
identify, based on the computing resource information, a second plurality of host devices from among the first plurality of host devices that fulfill the minimum resource requirement; and
assign at least a subset of the second plurality of host devices to a cluster used to execute the multiple instances of the software application.
